(19) United States
(12) Patent Application Publication
(10) Pub. No.: US 2025/0353177 A1
(43) Pub. Date: Nov. 20, 2025

(54) MOTION GENERATION FOR ROBOTIC CHARACTERS

(71) Applicants: DISNEY ENTERPRISES, INC., Burbank, CA (US); ETH Zürich, Zürich (CH)

(72) Inventors: Moritz Niklaus Bächer, Zürich (CH); Agon Serifi, Zürich (CH); Ruben Jelle Grandia, Zürich (CH); Lars Espen Knoop, Birmensdorf (CH)

(21) Appl. No.: 19/211,789

(22) Filed: May 19, 2025

Related U.S. Application Data
(60) Provisional application No. 63/649,214, filed on May 17, 2024.

(51) Int. Cl. B25J 9/16

(52) U.S. Cl. CPC B25J 9/1664; B25J 9/161; B25J 9/163

(57) ABSTRACT

A motion generation system includes a tracking model, executed by a processor, configured to track at least one kinematic reference motion of a robotic device; a reward surrogate model, executed by the processor, that evaluates a performance of the tracking model with respect to the at least one kinematic reference motion and estimates at least one reward for the tracking model based on the performance; and a generative model, executed by the processor, configured to generate a motion for the robotic device based on a contextual input and the estimated at least one reward, wherein the generative model is trained with a pre-training operation and a refinement operation separate from the pre-training operation.

### CROSS-REFERENCE TO RELATED APPLICATIONS

This application claims the benefit of priority under 35 U.S.C. § 119 (e) and 37 C.F.R. § 1.78 to provisional application No. 63/649,214 filed on May 17, 2024, titled “MOTION GENERATION FOR ROBOTIC CHARACTERS” which is hereby incorporated by reference herein in its entirety.

### BACKGROUND

Recent advancements in generative motion models have achieved remarkable results, enabling the synthesis of lifelike human motions from textual descriptions. These kinematic approaches, while visually appealing, often produce motions that fail to adhere to physical constraints, resulting in artifacts that impede real-world deployment.

The automated generation of realistic motions based on high-level user input is a crucial task in physics-based character animation and robotics. Traditionally, computer animation has emphasized kinematic-based approaches, which are well-suited for animated film and video games where visual storytelling takes precedence. Recent advances in generative models have demonstrated the ability to synthesize diverse and visually appealing motions when trained on large datasets. However, these kinematic-based generated motions do not strictly satisfy the constraints that come with a physics-based environment. As a result, the motions often contain artifacts such as floating, foot sliding, self-collisions, violations of joint limits, and dynamic imbalance, making it challenging to deploy these models in the real world. Although robust motion tracking controllers and tracking models exist, the resulting motion is inherently limited by the quality of the provided target motion.

Current systems that generate motion for simulated and real robotic devices from an input prompt suffer from many deficiencies. For example, while systems exist that can convert a string of text or a voice command into a set of robot poses, those poses may not be feasible within the capabilities of a real robotic figure. In some cases, such generated motions may result in instability of the robotic device during execution of a generated motion, which can cause the robotic device to fail to perform a desired motion. For example, existing systems may not respect the constraints of the real-world robotic device and its components, such as actuator velocity, acceleration, and torque limits. In addition, or alternately, existing systems may not be aware of mass, force, acceleration, and balance, which can lead to issues with a real robotic device.

This situation gives rise to a generation-to-real (or gen-to-real) gap. Such gaps can exist, for example, where a motion generator has been trained on human motion capture (or MoCap) data and then applied to a robotic device. Robotic devices seldom have the same joint flexibility, strength, fine motor control, range of motion, speed, weight, etc. as the humans whose captured motion was used to train the generator. Simply applying a model trained this way to a robotic device often results in unstable or undesirable motions, and may even cause the robotic device to fall, stumble, or collide with itself in unexpected ways. Similar problems can occur when applying a motion generation system between different robotic devices.

Improved systems and methods are desired that can close the gen-to-real gap for motion generators.

### BRIEF SUMMARY

In one embodiment, a motion generation system includes: a tracking model, executed by a processor, configured to track at least one kinematic reference motion of a robotic device; a reward surrogate model, executed by the processor, configured to evaluate a performance of the tracking model with respect to at least one kinematic reference motion and estimate at least one reward for the tracking model based on the performance; and a generative model, executed by the processor, configured to generate a motion for the robotic device based on a contextual input and the estimated at least one reward, wherein the generative model is trained with a pre-training operation and a refinement operation separate from the pre-training operation.

In some embodiments, the motion generation system further includes the robotic device that executes the motion generated by the generative model.

In some embodiments, the generative model includes a motion diffusion model.

In some embodiments, the pre-training operation includes providing, via the processor, a motion sequence to the generative model; adding noise, via the processor, to the motion sequence to generate a noisy motion sequence; and gradually removing, via the processor, the noise from the noisy motion sequence to reconstruct the motion sequence.

In some embodiments, the refinement operation includes generating, via the processor, a second motion sequence with the generative model; providing, via the processor, a reinforcement signal to the generative model based on the estimated at least one reward.

In some embodiments, the reinforcement signal includes a negative sum of the estimated at least one reward.

In some embodiments, the tracking model includes a trained machine learning model.

In some embodiments, the tracking model is trained separately from the reward surrogate model, and both of the tracking model and the reward surrogate model are frozen with respect to the generative model.

In some embodiments, the contextual input includes one or more of a textual input or an auditory input.

In some embodiments, the tracking model is further configured to track the at least one kinematic reference motion based on a state of the robotic device.

In one embodiment, a non-transitory computer-readable storage medium, the computer-readable storage medium including instructions that when executed by a computer, cause the computer to: execute a tracking model configured to track at least one kinematic reference motion of a robotic device; execute a reward surrogate model that evaluates a performance of the tracking model with respect to the at least one kinematic reference motion and estimates at least one reward for the tracking model based on the performance; execute a generative model configured to generate a motion for the robotic device based on a contextual input and the estimated at least one reward, wherein the generative model is trained with a pre-training operation and a refinement operation separate from the pre-training operation.

In some embodiments, the instructions further cause the computer to instruct the robotic device to perform the motion.

In some embodiments, the generative model includes a motion diffusion model.

In some embodiments, the instructions further cause the computer to execute a pre-training operation includes providing a motion sequence to the generative model; adding noise to the motion sequence to generate a noisy motion sequence; and gradually removing the noise from the noisy motion sequence to reconstruct the motion sequence.

In some embodiments, the instructions further cause the computer to execute a refinement operation including generating a second motion sequence with the generative model; providing a reinforcement signal to the generative model based on the estimated at least one reward.

In some embodiments, the reinforcement signal includes a negative sum of the estimated at least one reward.

In some embodiments, the tracking model includes a trained machine learning model.

In some embodiments, the tracking model is trained separately from the reward surrogate model, and both of the tracking model and the reward surrogate model are fixed with respect to the generative model.

In some embodiments, the contextual input includes one or more of a textual input or an auditory input.

In some embodiments, the tracking model is further configured to track the kinematic reference motion based on a state of the robotic device.

### BRIEF DESCRIPTION OF THE DRAWINGS

FIG. 1 is a schematic of an embodiment of a motion generation system, including an example of a robotic device executing a motion generated by the motion generation system.

FIG. 2A is a simplified schematic showing portions of a motion generation system according to the present disclosure.

FIG. 2B shows an example of a motion sequence suitable to train the motion generation systems of the present disclosure.

FIG. 2C is a simplified schematic of a method of aligning a generated motion with physical attributes of a real or simulated robotic device.

FIG. 3 is a flowchart of a method of pretraining a generative model of the motion generation systems of the present disclosure.

FIG. 4 is a flowchart of a method of refining training of a generative model of the motion generation systems of the present disclosure.

FIG. 5 is a simplified schematic of a method of deploying a generated motion to a real robotic device.

FIG. 6A illustrates a motion sequence for a robotic character generated by a prior motion generation system.

FIG. 6B illustrates a motion sequence for a robotic character generated by a motion generation system of the present disclosure

FIG. 7 compares experimental results of generating motion for a real, physical robotic device using a prior method and an embodiment of the present disclosure.

FIG. 8 compares experimental results of generating motion for a real, physical robotic device using a prior method and an embodiment of the present disclosure.

FIG. 9 is a simplified block diagram of components of a computing system of the motion generation system of FIG. 1 or a robotic device.

### DETAILED DESCRIPTION

The systems and methods disclosed close the generation-to-real gap for motion generation systems, including textual input based motion generation systems. The systems and methods disclosed integrate kinematic generative models with physics-based character control.

The motion generation systems and methods disclosed include a tracking model, or actor, which tracks one or more kinematic reference motions of a robotic device. In many embodiments, the tracking model takes a desired motion (e.g., from an animation) and outputs an action into an environment (real or virtual) including the robotic device. The action creates a state change in the robotic device in the environment. This state change is fed back to the tracking model in a closed loop. In many embodiments, the tracking model is a trained machine learning algorithm. In some embodiments, the tracking model is another type of algorithm.

The motion generation systems and methods include a reward surrogate model, or critic, which estimates at least one reward for the tracking model based on the performance of the tracking model at executing the kinematic reference motion. In many embodiments, the reward surrogate model is trained using a reinforcement learning (RL) algorithm. The reward surrogate model estimates the performance of the downstream non-differentiable control task, offering an efficient and differentiable loss function. This reward model is then employed to fine-tune a baseline generative model, ensuring that the generated motions are not only diverse but also physically plausible for real-world scenarios

The motion generation systems and methods include a generative model that generates a motion for the robotic device based on a contextual input such as a language input and the reward estimated by the reward surrogate model. This reward system accounts for the kinematic and dynamic aspects of the robotic device and is used to refine the training of the generative model to close the gen-to-real gap. In many embodiments, the generative model is a text-conditioned kinematic diffusion model that interfaces with the reinforcement learning-based tracking model.

The systems and methods disclosed align the output of kinematic generative models with the downstream task of tracking these motions with a physics-based or robotic character or robotic device. Evaluating the performance of a controlled character on generated motions requires long-horizon simulations, which are computationally expensive and non-differentiable. Even if a differentiable simulation is available, the highly non-linear nature of the articulated rigid-body system and the contact dynamics results in poorly behaved gradients.

The systems and methods estimate the expected performance of the downstream task. This estimation provides a differentiable and computationally efficient loss function to fine-tune the generative model. During deployment, the systems and methods interface the fine-tuned generative model with the existing tracking model. This processing is in contrast with training a generative controller directly, which typically results in a controller with a latent space that can be sampled. However, since these controllers are trained with reinforcement learning (RL), the network is typically limited to a shallow Multilayer Perceptron (MLP). By decoupling the generative model from the tracking model, we can employ more advanced networks and specialized training strategies. The systems and methods include a text-conditioned diffusion-based approach, although the disclosed fine-tuning strategy is applicable to generative models in general.

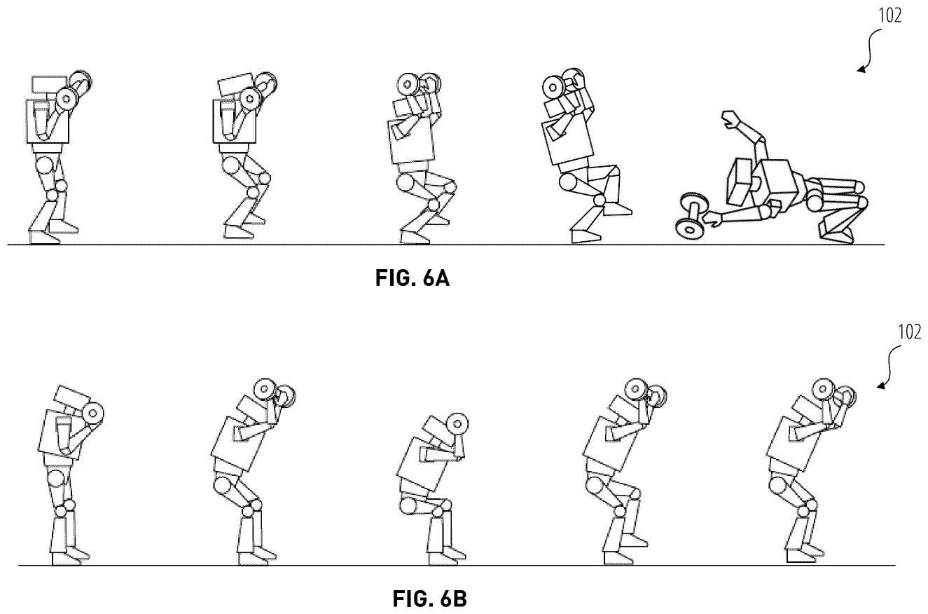

In summary, the present disclosure includes: a fine-tuning method for generative kinematic motion models using a reward surrogate model that offers an efficient, differentiable estimate of the downstream task. Examples of results of deploying the disclosed system and training methods to a real-world physical robotic device are included. As described further herein, the disclosed models, systems, and methods have been beneficially applied to the practical application of controlling real-world robotic systems. See FIGS. 6A, 6B, and 7-8, Tables 1 and 2, and related description.

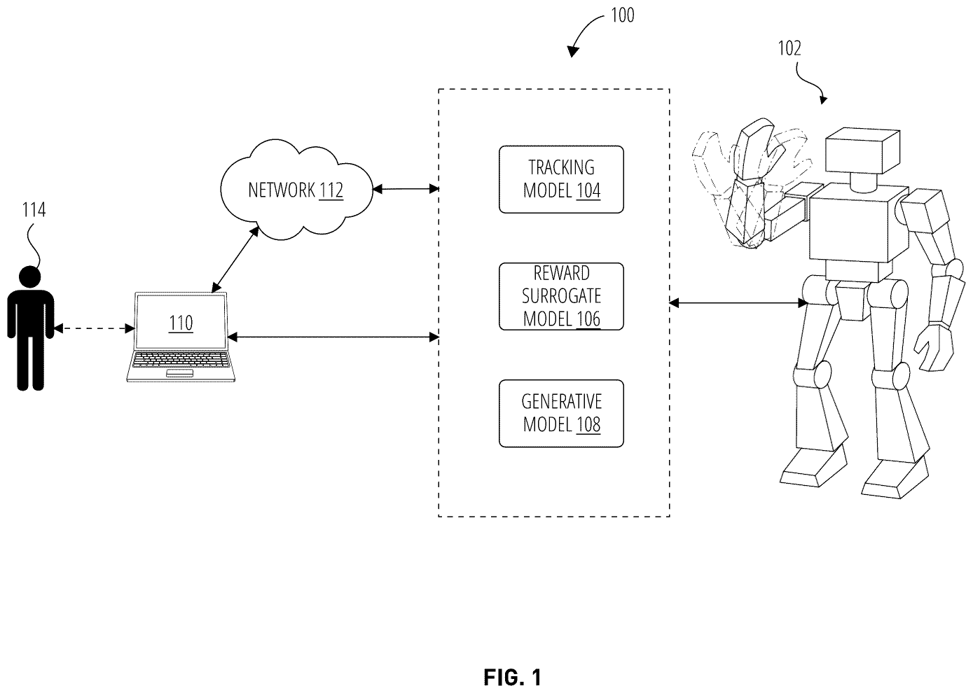

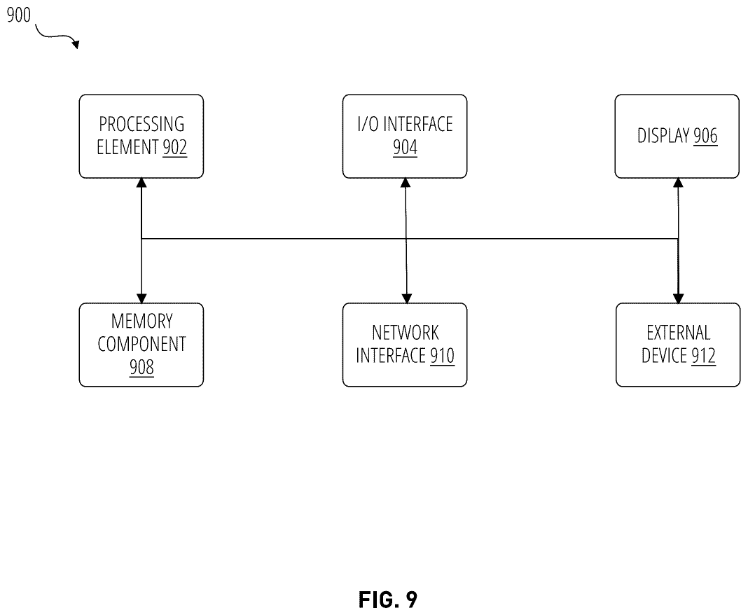

Turning to the figures, FIG. 1 is a schematic of an embodiment of a motion generation system. The motion generation system 100 includes a user device 110, a robotic device 102, and may optionally include a network 112. The robotic device 102 may be either a simulated robotic device 102 or a real, physical robotic device 102. The user device 110 may be any suitable computing device including a processing element 902 (e.g., described with respect to FIG. 9) that can execute instructions to carry out the methods disclosed herein, such as training or deploying any machine learning algorithm disclosed herein. The motion generation system 100 includes a tracking model 104, a reward surrogate model 106, and a generative model 108. As described herein in further detail, the tracking model 104 and the reward surrogate model 106 are used to train the generative model 108 to close the gen-to-real gap.

The user device 110 may be in electronic communication with the robotic device 102, either directly, or via the network 112. The user device 110 may receive input from a user 114 to cause the robotic device 102 to perform a certain motion or task. As shown for example in FIG. 1, the robotic device 102 may receive a command such as “Wave to the crowd” and the robotic device 102 may execute one or more methods herein that cause the robotic device 102 to wave its hand as though waving to a crowd.

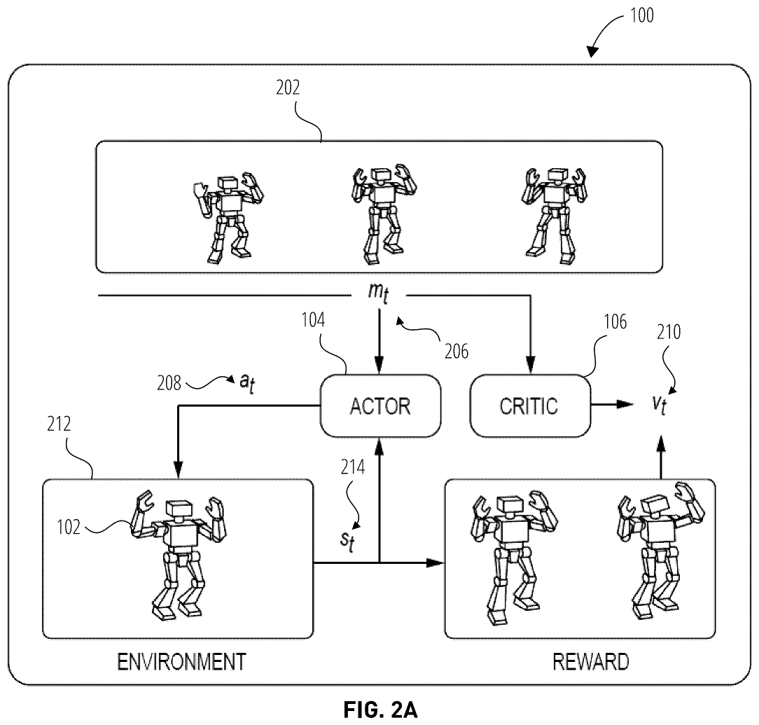

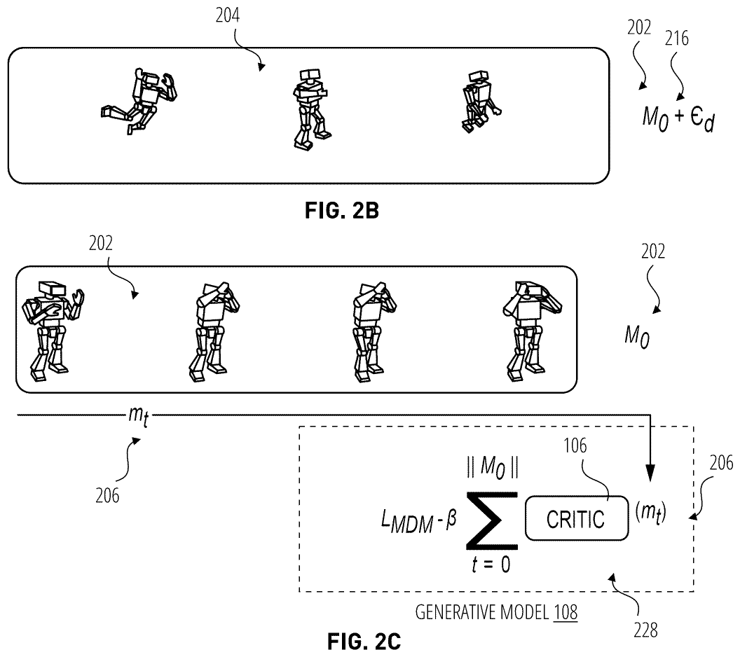

FIG. 2A is a simplified schematic showing portions of an embodiment of the motion generation system 100 and inputs and outputs thereof. The motion generation system 100 includes a tracking model 104 (i.e., an actor). The motion generation system 100 includes a reward surrogate model 106 (i.e., a critic).

As described further herein, to train the tracking model 104, motion sequence 202 for a robotic device 102 is provided. In many embodiments, the tracking model 104 includes a trained machine learning algorithm such as a neural network. In some embodiments, the tracking model 104 is another type of algorithm, such as a kinematic model of the robotic device 102. In many embodiments, tracking models may be shallow MLPs (e.g., with only one or two layers), or advanced transformer-based models trained using RL methods. In many embodiments, the kinematic model is a generative model, which may be fully-connected, convolutional or transformer-based architectures. The kinematic model may be trained through adversarial methods such as done with generative adversarial networks (GAN), or by learning to inverse the diffusion process as disclosed herein.

The motion sequence 202 is typically a virtual or animated motion sequence 202, but may be a real motion sequence 202 of a physical robotic device 102 in some embodiments. From the motion sequence 202, at least one kinematic reference motion 206 is extracted and provided to the tracking model 104. In some embodiments, the motion sequence 202 is sampled (e.g., uniformly sampled over time) during training. At inference time, a user can decide which kinematic reference motion 206 to track such as by providing a text or other contextual input to select the kinematic reference motion 206 to be extracted. The tracking model 104 generates an action 208 for the robotic device 102 based on the kinematic reference motion 206. The action 208 is provided to an environment 212 including the robotic device 102. Again, the environment 212 is virtual and the robotic device 102 is a virtual model of the robotic device 102 in many embodiments. However, where the robotic device 102 is a real, physical device, the environment 212 is any surroundings of the robotic device 102 (either indoors or outdoors) and the action 208 is provided to the robotic device 102 rather than the environment 212. The robotic device 102 executes the action 208 which creates a state 214 that is fed back to the tracking model 104, in a closed loop. The tracking model 104 may be trained with many kinematic reference motions 206 from the motion sequence 202 and may also be trained with kinematic reference motions 206 from different motion sequences 202. After the tracking model 104 is trained, its parameters may be frozen, such that training of other portions of the motion generation system 100 does not affect the parameters of the tracking model 104. As such, the tracking model 104 can be a “black box” with respect to the rest of the motion generation system 100, in that the motion generation system 100 does not have, or need, knowledge about the inner workings of the tracking model 104.

The reward surrogate model 106 may receive the same kinematic reference motions 206 as the tracking model 104. The tracking model 104 evaluates the state 214 of the environment 212 in response to the action 208. The state 214 can be any observable data that describes the environment 212 and/or the robotic device 120. Examples of states 214 can include joint positions, joint velocities, root linear and angular velocity, root orientation, etc. Based on how well the tracking model 104 performs the kinematic reference motion 206, the reward surrogate model 106 generates an estimated reward 210. For example, the reward surrogate model 106 may be a type or part of reinforcement learning algorithm.

The systems and methods assume the availability of a tracking controller conditioned on the kinematic reference motion 206, and a generative model 108 that produces kinematic motions. The systems and methods train the tracking controller and the generative model on the motion sequence 202 dataset. As described further herein, the development of the generative model 108 includes three parts: (i) training the reward surrogate model for the motion tracking task, (ii) aligning the generative model 108 with this reward surrogate model, and (iii) sequencing the generative model 108 with the tracking controller during deployment.

Motions over duration T are encoded with a T×(7+2J), where/presents the number of joints. This matrix includes measurements for root height, root linear velocity XY-plane, root angular velocity about z-axis, root pose (3-dimensional), and joint positions and velocities. This representation may be consistently applied across all stages of the method. Furthermore, motion data is normalized to the local pose of the character (e.g., by removing the heading direction from the pose so that the motion aligns with the x-axis being forward and z axis upward), where the x-axis aligns with the heading direction and the z-axis points upward. For example, a robotic device 102 may have a predefined “forward” heading direction (e.g., looking straight). This normalization helps assure that the poses performed are consistent with the direction the robotic device is facing. This normalization strategy decouples each pose from its absolute position and orientation in global coordinates thereby facilitating a more efficient utilization of the data resources. Mₜ is a subset of columns from matrix M corresponding to either a single pose or window of poses. If a motion is shorter, the systems and methods may pad the matrix with “zero” columns, restricting evaluations to loss or reward functions to the number of non-zero columns.

### Reward Surrogate Model Training

The tracking controller is a probability function, π(aₜ|sₜ, mₜ), where aₜ is the action taken, sₜ is the observed state at time t, and mₜ represents the target kinematic motion to the tracking controller. The environment reacts to the action by transitioning to the next state, sₜ₊₁, and providing a scalar reward rₜ=r(sₜ, aₜ, sₜ₊₁, mₜ). The reward reflects how accurately the resulting physical motion tracks the kinematic input.

During training, an episode (e.g., a prescribed motion sequence or time) is initialized by randomly choosing a motion and starting frame from the dataset. Then the motion sequence 202 is shifted by one frame within the same motion sequence 202 to retrieve the next reference. This process continues until the end of a motion sequence 202, randomly jumping to a new motion sequence if the episode has not terminated yet. Additionally, the domain is randomized to increase the robustness of the tracking controller and avoid overfitting to a single set of simulation parameters of the environment 212, randomizing rigid body masses, friction coefficients, and by introducing random disturbance forces (e.g., such as the robotic device may be subjected to from a random gust of wind). To further reduce the gen-to-real gap, the tracking model may include actuator models.

After training, the parameters of the tracking model 104 are frozen and the same environment is used to learn a function that estimates the performance of the tracking model 104 given a motion reference. The systems and methods estimate the expected discounted cumulative reward given the current motion reference.

$$v ( m ) = {𝔼}_{{{{s}_{0 : ∞}}_{{a}_{0 : ∞}}}_{{m}_{0 : ∞}}} [ {\sum }_{t = 0}^{∞} {γ}^{t} {r}_{t} \vert {m}_{0} = m , π ] \qquad Eq . 1$$

where the expectation is performed over state-action trajectories and future motion references, and y^{t}∈[0, 1] is the discount factor rₜ is the reward at time t, which has the same reward as during RL. In principle, though, the reward function can be altered this stage. The estimate in equation (1) is closely related to the value function used during RL, which is given by

$${v}^{RL} ( s , m ) = {𝔼}_{{{{s}_{1 : ∞}}_{{a}_{1 : ∞}}}_{{m}_{1 : ∞}}} [ {\sum }_{t = 0}^{∞} {γ}^{t} {r}_{t} \vert {s}_{0} = s , {m}_{0} = m , π ] \qquad Eq . 2$$

However, note that the RL value function has access to the current state of the character. The estimated reward 210 can therefore be understood as the value function averaged over the distribution of states, thus establishing a differentiable link between kinematic motion and expected reward. With the observation that the proposed critic is an RL critic with partial observations, the systems and methods apply standard value function estimation algorithms to train a network, v^{θ}(m), that approximates equation (1). The systems and methods disclosed may use the approach from proximal policy optimization (PPO), which estimates a value function target using truncated Generalized Advantage Estimation (GAE), corresponding to a truncated temporal difference (TD(λ)) estimate. Given a finite roll-out of the current tracking controller of length T, and given a current set of parameters θ, an updated value function estimate, [symbol] , is computed as

$${\hat{v}}_{t} = {v}_{t}^{θ} + {\sum }_{{t}^{′} = t}^{T - 1} {( γ λ )}^{( {t}^{′} - t )} {δ}_{{t}^{′}} \qquad Eq . 3$$

where δ_{t′} is the TD error at time t′, given by

$${δ}_{t} = {r}_{t} + γ {v}_{t + 1}^{θ} - {v}_{t}^{θ} \qquad Eq . 4$$

With the collected batch, the critic's parameters are updated according to a square loss function

$${min}_{θ} \sum {‖ {\hat{v}}_{t} - {v}_{t}^{θ} ‖}_{2}^{2} \qquad Eq . 5$$

Turning to FIG. 2B, the motion generation system 100 also includes a generative model 108. In many embodiments, the generative model 108 is a motion diffusion model. The generative model 108 takes a contextual input and produces an output motion for the robotic device 102. In many embodiments, the contextual input may be a language input. As used herein, language may include spoken words, sign language, symbols, body language (including poses), etc. The contextual input can be in any form suitable to be interpreted by the generative model 108. For example, a contextual input can be a string of text, a spoken command (either live or recorded), a visual command such as an input received from a machine vision system that detects a pose of a person and/or combinations of these.

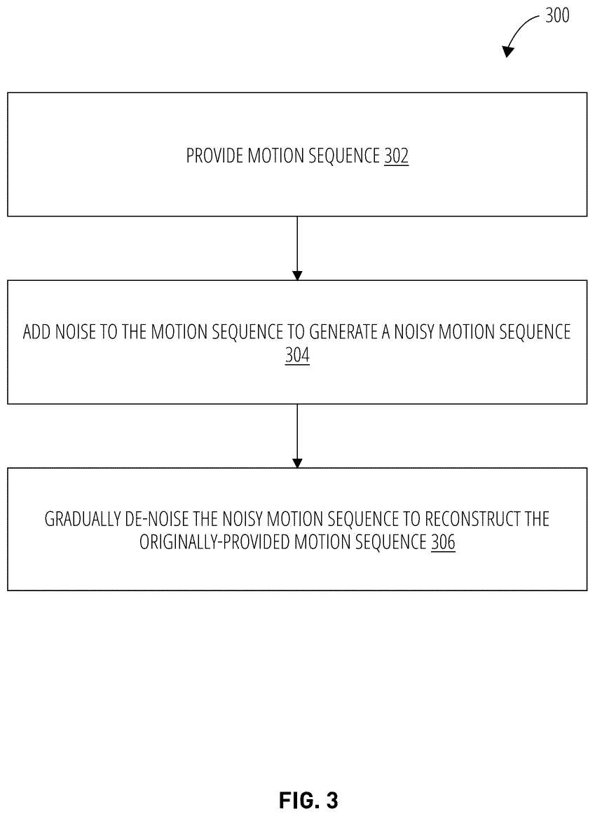

As shown for example in FIG. 2B, the generative model 108 is trained by using the output of the reward surrogate model 106 (e.g., the estimated reward 210) along with one or more kinematic reference motions 206 of one or more motion sequences 202. As described with respect to FIG. 3, the generative model 108 may be trained in two different operations, a pre-training operation, and a refinement operation.

FIG. 3 illustrates an example method 300 for pre-training a generative model 108. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence. Training the generative model includes a kinematic pre-training step (e.g., the method 300), followed by fine-tuning or refining (e.g., the method 400 described herein).

According to some examples, the method 300 includes providing a motion sequence at operation 302. A motion sequence may include hundreds or thousands of example motions, each of which may have one or many textual descriptions associated therewith. The motion sequence may be a collection of human motion capture data. In some embodiments, after removing motions shorter than two seconds and mirroring (e.g., to provide left and right side of the body motions) the motion sequence 202 may include multiple hours of motion sequences.

According to some examples, the method 300 includes adding noise to the motion sequence 202 to generate a noisy motion sequence at operation 304 in a diffusion process. See, e.g., FIG. 2B showing an example of a motion sequence 202 to which noise 216 has been added to generate a noisy motion sequence 204. For example, noise may be incrementally added to the motion sequence 202 through a series of steps until the motion sequence 202 generally resembles a Gaussian distribution.

In some embodiments, the operation 304 includes providing a clean motion sequence 202 (i.e., a motion sequence to which no noise has been added), denoted below as M, and progressively adding noise, resulting in a noisy motion sequence 204. The operation 304 can be expressed mathematically according to equation 6.

$$q ( {M}_{d} \vert {M}_{0} ) = 𝒩 ( {M}_{d} ; \sqrt{{α}_{d}} {M}_{0} , ( 1 - {α}_{d} ) I ) \qquad Eq . 6$$

with α_{d} representing a noise schedule that determines the intensity of the added noise.

In some embodiments, the diffusion process in operation 304 transforms the motion sequence 202 from clean motion to increasingly distorted motion or noisy motion sequence 204.

According to some examples, the method 300 includes gradually de-noise the noisy motion sequence 204 to reconstruct the originally-provided motion sequence at operation 306. In operation 306, the generative model 108 learns to progressively “denoise” or reconstruct the motion sequence 202 from the noisy motion sequence 204 by reversing the noise addition process performed in operation 304. For example, the generative model 108 may be trained to estimate the noise 216 that was added at each step of operation 304, using a predefined noise 216 schedule. Such training may involve minimizing a loss function 228 that measures the difference between the generative model's 108 estimated noise and the actual noise 216 added during that step. See, e.g., FIG. 2C. By learning to estimate and subtract the noise added in operation 304, the generative model 108 learns to generate plausible motions from random noise.

In some embodiments, the objective of the generative model 108 is to learn the reverse process: e.g., how to denoise a sequence and gradually reconstruct the clean motion sequence 202 from noisy motion sequence 204. The operation 306 may proceed to training the generative model 108 to estimate the motion sequence 202 (or clean motion M) using a parameterized function p_{ϕ}(M_{d}, d, c),

$${ℒ}_{MDM} = {‖ {M}_{0} - {p}_{ϕ} ( {M}_{d} , d , c ) ‖}_{2}^{2} \qquad Eq . 7$$

where c represents additional conditions like text prompts or other contextual information.

By providing these conditions, the generative model 108 can generate specific types of motions. This loss is minimized on randomly sampled motion-context pairs and a uniformly random diffusion steps d. During inference, a random noise motion is sampled from a standard Gaussian Distribution M_{D}˜ [symbol] (0, I) and D diffusion steps are applied to generate a clear motion M₀. Note that this process is not aware of physical properties that would be needed for true-to-life motion simulation.

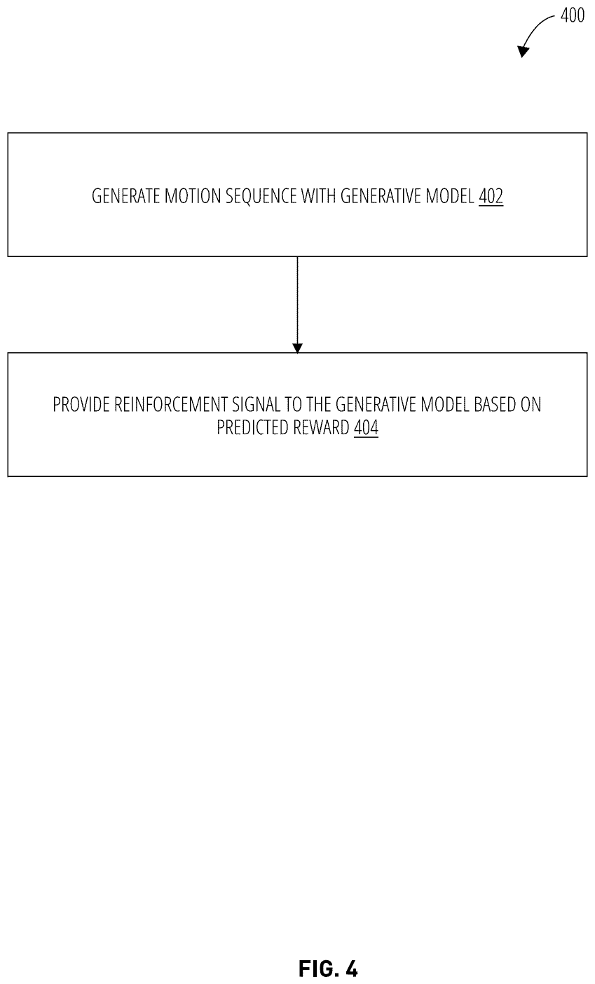

FIG. 4 illustrates an example method 400 for refining a pre-trained generative model 108. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes generating a motion sequence 202 with the pre-trained generative model at operation 402. For example, given a pre-trained generative model 108 and a reward surrogate model 106, the reward surrogate model 106 may be used as an additional loss to fine-tune the training of the generative model 108.

According to some examples, the method includes providing a reinforcement signal to the generative model based on estimated reward at operation 404. In the operation 404, the generative model 108 may generate a motion M=P_{ϕ}(M_{d}, d, c) and use the critic or reward surrogate model 106, with frozen parameters, to evaluate the expected performance of the tracking model 104 for that motion. The loss functions may ensure the generative model 108 generates motion according to the data distribution and textual conditioning. The negative sum of estimated rewards 210 from the reward surrogate model 106 may be used to indicate feasibility of the motion.

$${L}_{RoboMDM} = {ℒ}_{MDM} - β {\sum }_{t = 0}^{\vert \vert M \vert \vert} {v}^{θ} ( {m}_{t} ) \qquad Eq . 8$$

In the operation 404, the motion generation system 100 may sum over one or more motion windows of poses mₜ contained in the generated motion sequence 202. With this loss function, the generative model 108 is trained to shape motions into more realistic examples without losing contextual accuracy, achieving higher critic values, which indicates that a tracking controller of the generative model 108 can track the motion more accurately compared to prior methods.

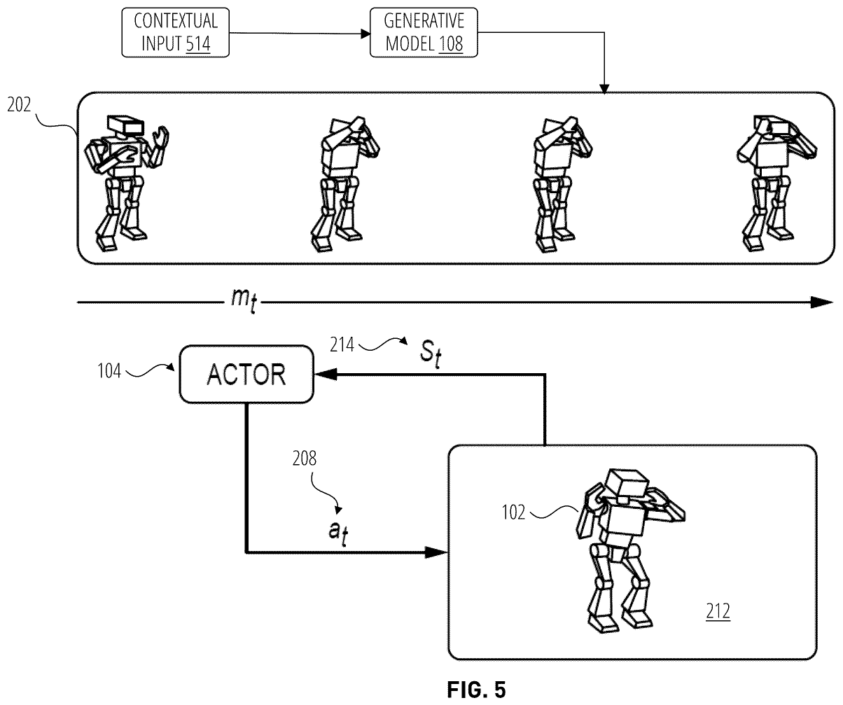

FIG. 5 shows an example schematic of a generative model 108 trained according to the systems and methods disclosed herein deployed to a physical robotic device 102. The trained generative model 108 receives a contextual input 514. As described herein, a contextual input 514 can be a string of text, a spoken command, an output from a machine vision algorithm, or any other input suitable to describe to the generative model 108 a motion to be performed by the robotic device 102. From the contextual input 514, the generative model 108 generates a motion sequence 202. The tracking model 104 generates one or more actions 208 based on the input motion sequence. The robotic device 102 performs the motion and the state 214 of the robotic device 102 is fed back to the tracking model 104.

### Example Results

The systems and methods were evaluated on a physical bipedal robotic device 102 with 20 degrees of freedom (DOFs). In simulation the robotic device 102 was operated on a torque-controlled system, with the tracking controller generating actuator positions that serve as inputs for the proportional-derivative (PD) controllers at each joint. The robotic device 102 estimates the root state using an onboard inertial measurement unit (IMU) is supported by a motion capture setup.

The generative model was trained using a human motion dataset retargeted to the robot. To stabilize the training the experimental setup used Exponential Moving Averaging (EMA). The prior motion diffusion model used 1000 diffusion steps (referred to as MDM-1K), with EMA comparable results can be achieved in just 50 diffusion steps (referred to as MDM). The motion generation of the generative model 108 was evaluated compared against the prior methods where the character's tracking controller (no-external forces applied) was used as the projection step. To evaluate the motion quality and diversity, different metrics were used, such as the Frèchet Inception Distance (FID) which measures the disparity between the feature distribution of real and generated motions by utilizing a pre-trained inception net-work. R-Precision compares the ground truth text description and 31 random text descriptions by measuring the Euclidean distance between the text embeddings and generated motion embedding, top-3 accuracy is reported. A multimodal distribution evaluates mode coverage by measuring the Euclidean distance between motion features and text features. To evaluate diversity the variance between generated motions and real motions were compared and the multimodality, which measures how well motions differ within the same text description. The evaluation additionally used a realism score, which reports the accumulated value estimated by the reward surrogate model 106 as

$${\sum }_{t = 0}^{‖ M ‖} {v}^{θ} ( {m}_{t} ) \qquad Eq . 9$$

and indicates the feasibility of the motion.

Note that the training motion sequences 202 have a much lower realism score than the outputs of the generative model 108. This is because motions in the dataset can be corrupted, e.g., have missing frames, or discontinuities. The trained generative model 108 further aligns the generated motions closer to realistically feasible motions.

In many embodiments, the robotic device 102 will differ from the device or person used to define the kinematic reference motions, which will introduce artifacts that lead to physical artifacts. For example, simply downscaling a jump performed by a human to the character with different mass properties will not result in the correct fly time (e.g., the time the robotic device 102 should be in the air after executing a jump). FIG. 6A and FIG. 6B show a comparison between a prior method (MDM) and trained generative model 108 of the present disclosure where the generator is conditioned on lifting a dumbbell over its head.

FIG. 6A shows an example of a robotic device 102 trained by prior methods and systems attempting to lift a dumbbell over its head. As shown in the sequence of motions, the robotic device 102 is unstable and falls over before accomplishing the task.

FIG. 6B shows an example of a robotic device 102 trained by the systems and methods herein, also attempting to lift a dumbbell over its head. In this case, the trained generative model 108 is able to close the gen-to-real gap and enable the robotic device 102 to lift the dumbbell successfully, without falling over.

During RL-training the tracking controller learns to avoid collision between different rigid bodies, e.g., a head and an arm. This means that motions that would lead to a collision are tracked less accurately than motions that circumvent the collision. In the trained generative model 108 of the present disclosure, this effect can be observed as well. To avoid collisions, the generative model 108 keeps a larger margin between rigid bodies (e.g., a head and an arm), or moves the arm in front of the head to avoid a collision without losing articulation. The results show that the present system and methods resulted in fewer collisions than prior methods and systems.

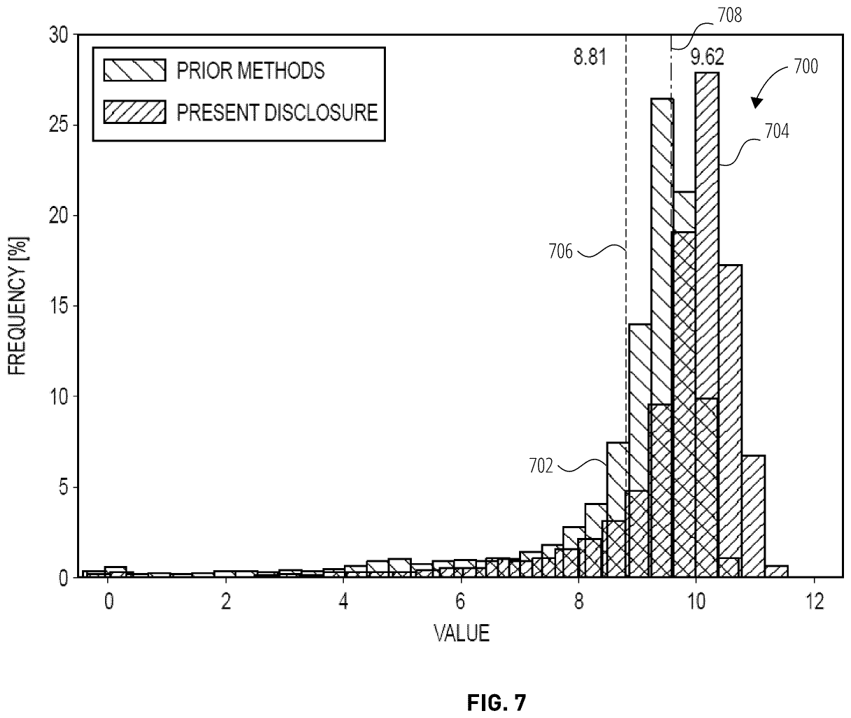

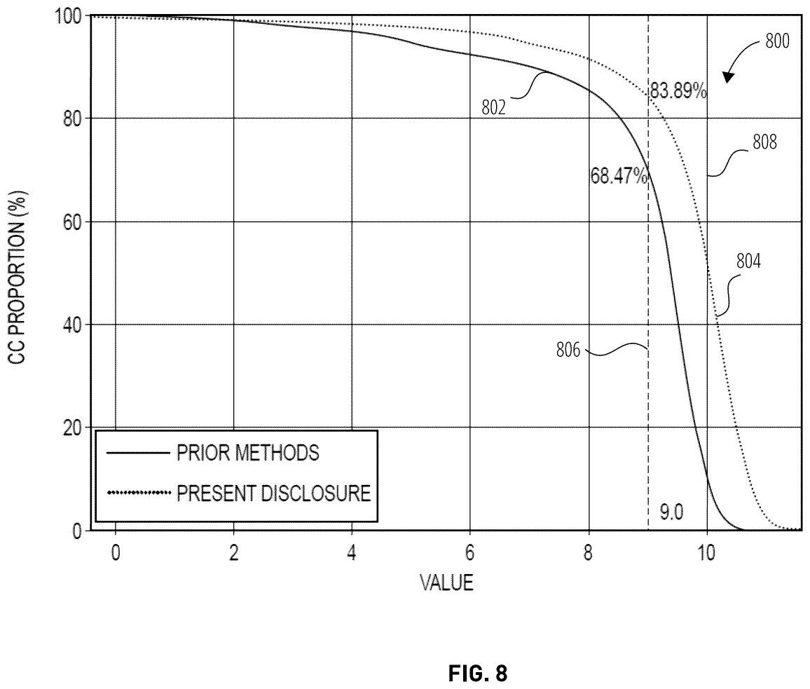

The resulting motions of trained generative model 108 of the present disclosure can be better tracked on physical hardware. For example, motions were generated using prior methods and trained generative model 108 of the present disclosure using the same text descriptions, the same tracking controller on the robotic device 102 and condition the tracking controller on the generated motions. See FIG. 7 and FIG. 8 and accompanying description. Additional example results are presented in Tables 1 and 2.

TABLE 1
Kinematic Motion Generation.

| | R Precision | | MultiModal | | Multi- | |
|---|---|---|---|---|---|---|
| Method | top 3 ↑ | FID ↓ | Dist ↓ | Diversity→ | modality ↑ | Realism ↑ |
| Real | 0.696^{±.003} | 0.002^{±.000} | 3.799^{±.014} | 8.958^{±.102} | — | 6.774^{±.002} |
| MDM-1K (prior) | 0.675^{±.013} | 0.688^{±.090} | 3.840^{±.039} | 8.952^{±.060} | 2.355^{±.148} | 8.392^{±.036} |
| MDM (prior) | 0.680^{±.008} | 0.415^{±.045} | 3.831^{±.028} | 9.074^{±.135} | 2.068^{±.067} | 8.730^{±.018} |
| Generative model | 0.684^{±.007} | 0.472^{±.023} | 3.835^{±.020} | 9.170^{±.064} | 2.087^{±.101} | 9.562^{±.017} |
| (present disclosure) | | | | | | |

±indicates the 95% confidence interval.

TABLE 2
Motion Tracking. Tracking performance of the tracking controller
on motions generated from a prior method (MDM) and an embodiment
of the generative model of the present disclosure.

| | Tracking Error | | | | |
|---|---|---|---|---|---|
| Input | lin vel | ang vel | root rot | upDOF | loDOF |
| MDM (prior) | 4.90 m/s | 0.29 rad/s | 4.13° | 10.88° | 16.11° |
| Generative | 3.43 m/s | 0.23 rad/s | 2.34° | 9.36° | 11.44° |
| model | | | | | |
| (present | | | | | |
| disclosure) | | | | | |

FIG. 7 is an example of results 700 comparing prior methods with the methods and systems disclosed herein. The frequency distribution 702 is an example from prior methods and systems. The frequency distribution 704 is an example from an embodiment of the present disclosure. Both the frequency distribution 702 and the frequency distribution 704 show estimated rewards 210 generated by the value function used by the reward surrogate model 106. In this example, a value of 10 represents a desired match between the motion the robotic device 102 was asked to perform (e.g., via a contextual input) and its actual performance. As shown in FIG. 7, the frequency distribution 704 is closer to the desired value of 10 than the frequency distribution 702. The frequency distribution 704 also has a mean 708 value of 9.62, which is closer to the desired value of 10 than the mean 706 value of 8.81 of prior methods.

FIG. 8 shows example results 800 comparing the presently-disclosed methods and systems with that of prior methods and systems. The results 800 shows a class-conditional proportion (which presents how many motions have at least this value) with respect to an estimated reward 210 generated by the reward surrogate model 106. The class-conditional proportion 802 is an example from prior methods. The class-conditional proportion 804 is an example from an embodiment of the present disclosure. Higher numbers indicate better performance of the respective models. As shown in FIG. 8, the robotic device 102 trained with the present methods and systems has a more accurate class-conditional proportion 804 than that of prior methods and systems. The mean 808 (83.89%) of the class-conditional proportion 804 is superior to the mean 806 (68.47%) of the class-conditional proportion 802 of the prior systems and methods.

FIG. 9 is a simplified block diagram of components of a computing system 900 of the motion generation system 100, such as the user device 110, the robotic device 102, etc. For example, the processing element 902 and the memory component 908 may be located at one or in several computing systems 900. This disclosure contemplates any suitable number of such computing systems 900. For example, the user device 110 may be a desktop computing system, a mainframe, a blade, a mesh of computing systems 900, a laptop or notebook computing system 900, a tablet computing system 900, an embedded computing system 900, a system-on-chip, a single-board computing system 900, or a combination of two or more of these. Where appropriate, a computing system 900 may include one or more computing systems 900; be unitary or distributed; span multiple locations; span multiple machines; span multiple data centers; or reside in a cloud, which may include one or more cloud components in one or more networks. A computing system 900 may include one or more processing elements 902, an input/output I/O interface 904, one or more external devices 912, one or more memory components 908, and a network interface 910. Each of the various components may be in communication with one another through one or more buses or communication networks, such as wired or wireless networks, e.g., the network 112. The components in FIG. 9 are exemplary only. In various examples, the computing system 900 may include additional components and/or functionality not shown in FIG. 9.

The processing element 902 may be any type of electronic device capable of processing, receiving, and/or transmitting instructions. For example, the processing element 902 may be a central processing unit, microprocessor, processor, or microcontroller. Additionally, it should be noted that some components of the computing system 900 may be controlled by a first processing element 902 and other components may be controlled by a second processing element 902, where the first and second processing elements may or may not be in communication with each other.

The I/O interface 904 allows a user to enter data in to computing system 900, as well as provides an input/output for the computing system 900 to communicate with other devices or services. The I/O interface 904 can include one or more input buttons, touch pads, touch screens, and so on.

The external device 912 are one or more devices that can be used to provide various inputs to the computing systems 900, e.g., mouse, microphone, keyboard, trackpad, sensing element (e.g., a thermistor, humidity sensor, light detector, etc. The external devices 912 may be local or remote and may vary as desired. In some examples, the external devices 912 may also include one or more additional sensors.

The memory components 908 are used by the computing system 900 to store instructions for the processing element 902 such as for executing the methods disclosed herein such as the method 300 and/or the method 400, various training data, the motion sequences 202, as well as store data, user preferences, alerts, etc. The memory components 908 may be, for example, magneto-optical storage, read-only memory, random access memory, erasable programmable memory, flash memory, or a combination of one or more types of memory components.

The network interface 910 provides communication to and from the computing system 900 to other devices. The network interface 910 includes one or more communication protocols, such as, but not limited to Wi-Fi, Ethernet, Bluetooth, etc. The network interface 910 may also include one or more hardwired components, such as a Universal Serial Bus (USB) cable, or the like. The configuration of the network interface 910 depends on the types of communication desired and may be modified to communicate via Wi-Fi, Bluetooth, etc.

The display 906 provides a visual output for the computing system 900 and may be varied as needed based on the device. The display 906 may be configured to provide visual feedback to the user 114 and may include a liquid crystal display screen, light emitting diode screen, plasma screen, or the like. In some examples, the display 906 may be configured to act as an input element for the user 114 through touch feedback or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in frozen relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A motion generation system comprising:
a tracking model, executed by a processor, configured to track at least one kinematic reference motion of a robotic device;
a reward surrogate model, executed by the processor, configured to evaluate a performance of the tracking model with respect to at least one kinematic reference motion and estimate at least one reward for the tracking model based on the performance; and
a generative model, executed by the processor, configured to generate a motion for the robotic device based on a contextual input and the estimated at least one reward, wherein the generative model is trained with a pre-training operation and a refinement operation separate from the pre-training operation.

2. The motion generation system of claim 1, further comprising the robotic device that executes the motion generated by the generative model.

3. The motion generation system of claim 1, wherein the generative model comprises a motion diffusion model.

4. The motion generation system of claim 1, wherein the pre-training operation comprises:
providing, via the processor, a motion sequence to the generative model;
adding noise, via the processor, to the motion sequence to generate a noisy motion sequence; and
gradually removing, via the processor, the noise from the noisy motion sequence to reconstruct the motion sequence.

5. The motion generation system of claim 1, wherein the refinement operation comprises:
generating, via the processor, a second motion sequence with the generative model;
providing, via the processor, a reinforcement signal to the generative model based on the estimated at least one reward.

6. The motion generation system of claim 5, wherein the reinforcement signal comprises a negative sum of the estimated at least one reward.

7. The motion generation system of claim 1, wherein the tracking model comprises a trained machine learning model.

8. The motion generation system of claim 1, wherein the tracking model is trained separately from the reward surrogate model, and both of the tracking model and the reward surrogate model are frozen with respect to the generative model.

9. The motion generation system of claim 1, wherein the contextual input comprises one or more of a textual input or an auditory input.

10. The motion generation system of claim 1, wherein the tracking model is further configured to track the at least one kinematic reference motion based on a state of the robotic device.

11. A non-transitory computer-readable storage medium, the computer-readable storage medium including instructions that when executed by a computer, cause the computer to:
execute a tracking model configured to track at least one kinematic reference motion of a robotic device;
execute a reward surrogate model that evaluates a performance of the tracking model with respect to the at least one kinematic reference motion and estimates at least one reward for the tracking model based on the performance;
execute a generative model configured to generate a motion for the robotic device based on a contextual input and the estimated at least one reward, wherein the generative model is trained with a pre-training operation and a refinement operation separate from the pre-training operation.

12. The non-transitory computer-readable storage medium of claim 11, wherein the instructions further cause the computer to instruct the robotic device to perform the motion.

13. The non-transitory computer-readable storage medium of claim 11, wherein the generative model comprises a motion diffusion model.

14. The non-transitory computer-readable storage medium of claim 11, wherein the instructions further cause the computer to execute a pre-training operation comprising:
providing a motion sequence to the generative model;
adding noise to the motion sequence to generate a noisy motion sequence; and
gradually removing the noise from the noisy motion sequence to reconstruct the motion sequence.

15. The non-transitory computer-readable storage medium of claim 11, wherein the instructions further cause the computer to execute a refinement operation comprising:
generating a second motion sequence with the generative model;
providing a reinforcement signal to the generative model based on the estimated at least one reward.

16. The non-transitory computer-readable storage medium of claim 15, wherein the reinforcement signal comprises a negative sum of the estimated at least one reward.

17. The non-transitory computer-readable storage medium of claim 11, wherein the tracking model comprises a trained machine learning model.

18. The non-transitory computer-readable storage medium of claim 11, wherein the tracking model is trained separately from the reward surrogate model, and both of the tracking model and the reward surrogate model are fixed with respect to the generative model.

19. The non-transitory computer-readable storage medium of claim 1, wherein the contextual input comprises one or more of a textual input or an auditory input.

20. The non-transitory computer-readable storage medium of claim 11, wherein the tracking model is further configured to track the kinematic reference motion based on a state of the robotic device.
